(19) United States
(12) Patent Application Publication
(10) Pub. No.: US 2014/0169758 A1
(43) Pub. Date: Jun. 19, 2014

(54) Systems and Methods for Tracking Players based on Video data and RFID data

(71) Applicants: Michael Sapoznikow, Sausalito, CA (US); Russell J. Hewett, Belmont, MA (US)

(72) Inventors: Michael Sapoznikow, Sausalito, CA (US); Russell J. Hewett, Belmont, MA (US)

(21) Appl. No.: 13/962,806

(22) Filed: Aug. 8, 2013

Related U.S. Application Data
(60) Provisional application No. 61/681,470, filed on Aug. 9, 2012.

(51) Int. Cl. G11B 27/10; G06K 7/10

(52) U.S. Cl. CPC G11B 27/10; G06K 7/10009
USPC 386/241

(57) ABSTRACT

A system and method to track players on a sports field are disclosed. In some embodiments, optical tracks from a video may be generated. An identity of a player corresponding to each of the optical tracks may be determined based on radio-frequency identification (RFID) data. For example, RFID antennas may be positioned relative to a sports field. Timestamps may be generated whenever a player on the sports field passes near an RFID antenna. In some embodiments, the timestamps may be used to identify a player associated with an optical track.

### RELATED APPLICATION

This application claims the benefit under 35 USC 119 of U.S. Provisional Application No. 61/681,470 filed on Aug. 9, 2012 and entitled “SYSTEMS AND METHODS FOR TRACKING PLAYERS BASED ON VIDEO DATA AND RFID DATA”, which is expressly incorporated herein by reference in its entirety.

### FIELD

The present disclosure relates to systems and methods for tracking. In some embodiments, the present disclosure relates to systems and methods for tracking players engaged in a sporting or athletic endeavor based on video data and radio-frequency identification (RFID) data.

### BACKGROUND

This invention draws its inspiration from tracking systems associated with sporting or athletic endeavors, though the underlying principles and techniques are applicable to other applications. Conventional sports tracking systems use complex technology, including complex sensing technology, to track devices and players in sporting events. The complex technology incorporates special-purpose video cameras and computer algorithms to track people and devices, such as a moving puck in an ice hockey game.

However, the conventional sports tracking systems are expensive to implement and maintain. For example, such systems may rely on very expensive camera-based systems that utilize multiple cameras in set positions around a sports field (e.g., a hockey rink, basketball court, football field, baseball diamond, etc.). Such cameras incorporate servos and other sensors for identifying angle, tilt, and zoom of the cameras as well as complex software for generating a three-dimensional model of the sports field. The hardware and software used in such systems is very expensive and very sensitive to any change—for example, a small and unexpected physical shift to one camera may cause the system to fail. Such systems may only be practical at the highest levels of sport, where cost structures permit investment in expensive equipment and in personnel to manage and support such systems. As such, what is needed is a simpler, more robust, and lower cost system that may be more practical for low-level professional, university level or amateur level sports organizations who do not have the same resources available, and that may be beneficially coupled with the preexisting systems in use at the highest levels of sport.

### SUMMARY OF THE INVENTION

An optical system, including one or more video cameras, is used to track entities in the field of view of the optical system. The optical system tracks individual entities and provides position data (for example, x-y position over time) for each optically tracked entity.

The entities being tracked are outfitted with non-visual identifiers. These non-visual identifiers may be Radio Frequency Identifiers (RFIDs or RFID transmitters) or the equivalent. The non-visual identifiers are used to resolve ambiguities regarding the identities of the optically tracked entities. In this way, the optical tracks may be associated with specific entities using the non-visual identifiers.

In some embodiments, the ambiguity comprises an uncertainty of target tracking software to identify an identity of the first player associated with the first optical track from the video data.

In some embodiments, the field of view comprises a hockey rink where each player on the rink is associated with an RFID transmitter associated with a unique identifier. In other embodiments, the field of view comprises any other sports field. In still other embodiments, the field of view is any other surface on which entities may be positioned.

The RFID transmitters are capable of being read by an RFID antenna. In some embodiments, RFID antennas are placed in a ring around the field of view. In other embodiments, RFID antennas are placed in a grid pattern that canvasses the field of view. In yet other embodiments, just one or a few RFID antennas are used. For example, one or a few RFID antennas may be placed in or near an entrance/egress point or other “choke point.”

Players are not the only entities that might be tracked. The system might be used to track equipment, such as a ball or puck. Non-sporting embodiments are also possible. For example, the systems and methods might be beneficially applied at transit stations or other transit facilities (commuters frequently carry RFID tags used for transit). The entities who are tracked could be non-human entities, including entities larger than humans (e.g., automobiles with RFID-based toll passes as they move through any intersection) or entities smaller than humans (e.g., agricultural animals with ear tags). Other potential applications include tracking inventory or equipment, tracking shipping containers in a sea port or airport, and tracking the movement of people through a facility, for example for security purposes.

### BRIEF DESCRIPTION OF THE DRAWINGS

For purpose of explanation, several embodiments of the disclosure are set forth in the following figures.

FIG. 1 is a flow diagram of an example method to track players based on video data and RFID data.

FIG. 2 illustrates an example environment for a system and/or method for tracking players based on video data and RFID data.

FIG. 3 illustrates an example environment comprising an overhead video camera and a plurality of RFID antennas in accordance with some embodiments.

FIG. 4 is a flow diagram for tracking a player based on an optical track of a player and a timestamp associated with the player in accordance with some embodiments of the present disclosure.

FIG. 5 is a flow diagram for identifying a player associated with an ambiguous optical track in accordance with some embodiments.

FIG. 6 is another flow diagram for identifying a player associated with an ambiguous optical track in accordance with some embodiments.

FIG. 7 is a block diagram of an example hardware configuration for receiving raw input data passed to the system for analysis.

FIG. 8 is a block diagram for processing raw input data into a form that can be aggregated and analyzed by the system.

FIG. 9 is a block diagram for analyzing processed data to identify optical tracks and maintain game status information.

FIG. 10 depicts a diagram illustrating an exemplary computing system for execution of the operations comprising various embodiments of the disclosure.

### DETAILED DESCRIPTION

The systems and methods described in this section relate to embodiments of the invention directed to tracking players based on video data and RFID data.

In the following detailed description, numerous specific details are set forth in order to provide a thorough understanding of the present disclosure. For example, the described embodiments are set in a sporting or athletic context, and often specifically the context of ice hockey. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

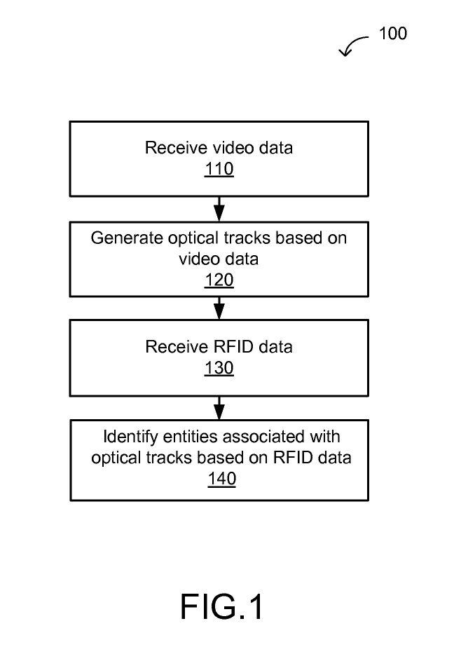

FIG. 1 is a flow diagram of an example method 100 to track players based on video data and RFID data. In general, the method 100 may be used to identify and track one or more players on a sports field (e.g., a hockey rink, basketball court, football field, baseball diamond, etc.).

As shown in FIG. 1, the method 100 may receive, at step 110, video data. In some embodiments, the video data may be received from one or more cameras. For example, a single overhead camera or a plurality of overhead cameras linked to form a single video or image of a sports field may record the entire sports field. At step 120, players may be tracked based on the video data. For example, target tracking algorithms (e.g., computer vision techniques) may track the position over time of one or more players on the sports field. In some embodiments, the target tracking algorithms may generate optical tracks of the players on the sports field. In some embodiments, the optical track of a player may comprise a path or position over time of the player on the sports field. As such, a plurality of optical tracks for a plurality of players may be generated based on the video data.

Optical systems, and in particular overhead cameras, typically cannot specifically identify a player on their own. RFIDs are associated with each player to be tracked and used to associate individual optical tracks generated by the optical system with particular players.

Optical tracks are associated with particular players after the optical tracks begin (e.g., when a player enters the field of view). The identity of each player is determined using the RFIDs when an unambiguous determination becomes possible, based on the configuration of the system. In addition, in some embodiments, the identity of a player associated with an optical track may become lost or ambiguous during the course of play. Use of RFID tag data to re-identify particular players may therefore become necessary. The target tracking algorithms may at times be unable to determine which player is associated with each of the previously generated optical tracks (i.e., the optical tracks may continue to be generated without verifying the identity of the player associated with the optical track). For example, players may collide on the sports field, or a plurality of players may come off a bench or a sideline at the same time, or a player may pass through a location where video coverage is weak or not available. In those situations, use of RFID tag data to re-identify particular players would occur.

In some embodiments, the method 100 receives, at step 130, RFID data. In some embodiments, the RFID data may be received from one or more RFID antennas. Next, at step 140, the identity of players associated with the optical tracks generated from the video data may be identified based on the RFID data. For example, players may be identified or associated to an optical track by using the RFID data. Further details with regard to the steps and implementation of the method 100 are described in further detail below.

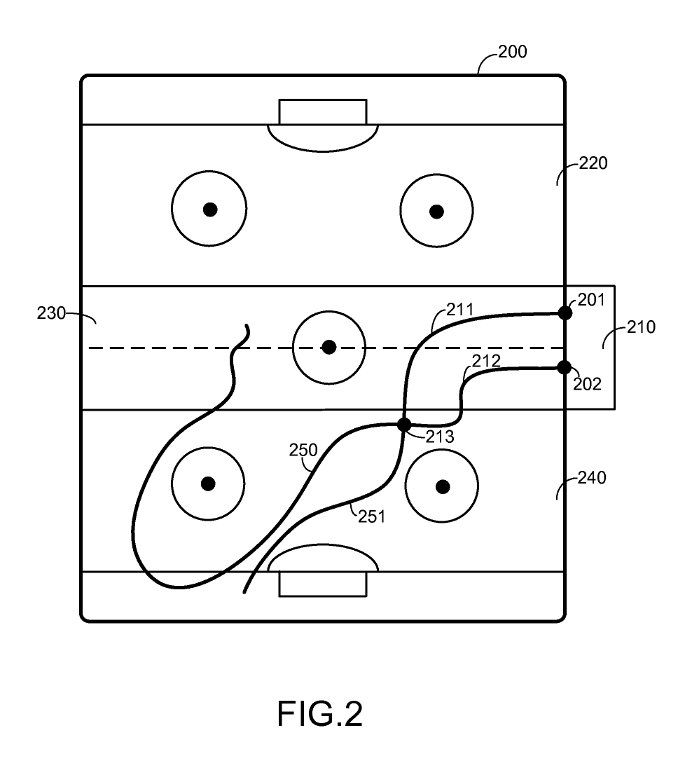

FIG. 2 illustrates an example environment 200 for a system and/or method for tracking players based on video data and RFID data. In general, the environment 200 may comprise one or more overhead cameras and one or more RFID antennas to identify a player associated with an optical track. FIG. 2 represents, in part, the view from an overhead camera—the overhead camera is not pictured.

As shown in FIG. 2, the environment 200 may comprise a sports field. In some embodiments, the sports field may comprise an ice hockey rink, basketball court, football field, baseball field, or any other surface. For purposes of illustration, the following disclosure relates to a sports field comprising a hockey rink. However, the following systems and methods for tracking players based on video data and RFID data may be used for any other type of sports field or sports activity as well as for non-sports activities. As such, the following systems and methods are not intended to be limited to hockey rinks and hockey players.

As previously disclosed, the environment 200 may comprise a hockey rink. In some embodiments, the hockey rink may comprise a plurality of zones or regions. For example, the hockey rink may comprise (from the perspective of one team) an attacking zone 220, neutral zone 230, and a defending zone 240. Furthermore, the hockey rink may comprise a player bench 210. One or more players move throughout the hockey rink over the time period of a game. For example, a player may travel from the player bench 210 to the neutral zone 230 and then to the defending zone 240. The path of travel of the player may be detected. For example, one or more overhead video cameras may be positioned over the hockey rink such that at least one overhead video camera records each portion of the surface of the hockey rink. In some embodiments, the video data may be used to track a player on the hockey rink. For example, target tracking software may receive the video output from the overhead video camera(s) and track an optical path 212 of a first player 202. In some embodiments, the target tracking software may further track an optical path 211 of a second player 201. The first player 202 and the second player 201 may enter the hockey rink from a same area. For example, the first player 202 and the second player 201 may enter the hockey rink from the player bench 210. Target tracking algorithms may be unable to correctly identify the player associated with each optical track that has been detected. For example, in such a case, the optical target tracking software may detect optical tracks 211 and 212, but may be unable to identify which player (e.g., first player 202 or second player 201 or other possible players) is associated with each of the optical tracks 211 and 212.

In other situations, the first player 202 and the second player 201 may move through the hockey rink and collide during the game. As such, the optical path 212 associated with the first player 202 may intersect with the optical path 211 associated with the second player 201. For example, the first player 202 and the second player 201 and the associated optical tracks 212 and 211 may intersect at point 213 on the hockey rink. In some embodiments, the target tracking software may be unable to identify the player associated with each of the optical tracks after the point 213. For example, optical paths 250 and 251 may be generated after the point 213, but the identity of a player associated with each of the optical paths 250 and 251 may not be able to be determined from the video data. As such, in certain situations, such as a plurality of players coming off the bench 210 or a plurality of players colliding at a point 213 or players passing through a region of weak or no video coverage, the inability of the target tracking software to identify a player associated with an optical track may occur.

The position of the puck (or ball in other sports) might also be tracked. The puck could be tracked through visual means, through non-visual means, or through a combination of visual and non-visual means.

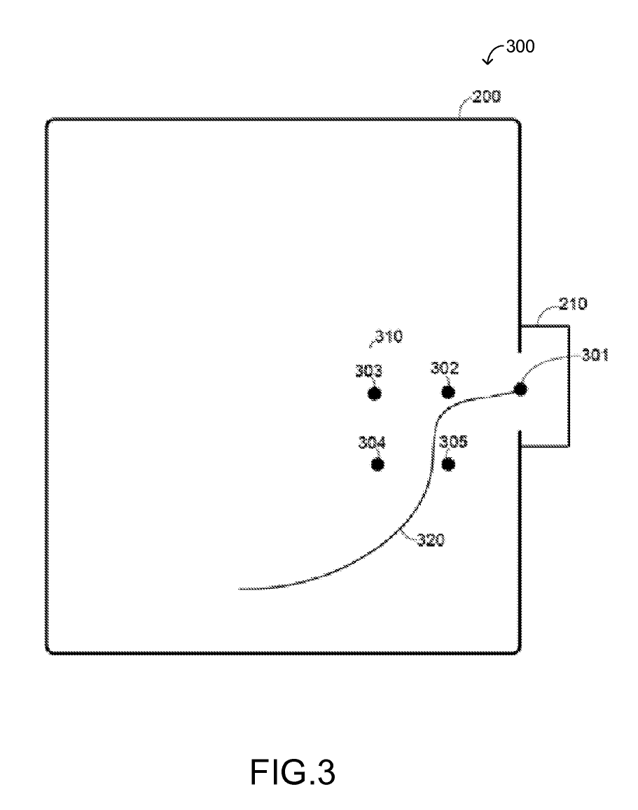

FIG. 3 illustrates an example environment 300 comprising an overhead video camera and a plurality of RFID antennas in accordance with some embodiments. In general, the environment 300 may comprise at least one overhead video camera and at least one RFID antenna to track an optical path and to identify a player associated with the optical path. FIG. 3 represents, in part, the view from an overhead camera—the overhead camera is not pictured.

Each player to be tracked wears an RFID. The RFID may be of any known type, including active or passive RFIDs. It may be placed on or in any article of clothing or equipment associated with the player. In one embodiment, the RFID is a passive RFID that is sown into the player's jersey.

As shown in FIG. 3, the environment 300 may comprise the sports field 200 (e.g., a hockey rink) where one or more players may travel throughout the sports field. In some embodiments, the environment 300 may comprise one or more overhead video cameras and a plurality of RFID antennas 301, 302, 303, 304, and 305. In some embodiments, the RFID antennas 301, 302, 303, 304, and 305 may be placed over the sports field. In the same or alternative embodiments, the RFID antennas 301, 302, 303, 304, and 305 may be placed over the sports field in a mesh arrangement. The RFID antennas 301, 302, 303, 304, and 305 may be configured to receive or detect a signal from an RFID transmitter. In some embodiments, each of the players that travel on the sports field 200 may be associated with an RFID transmitter. For example, an RFID transmitter may be integrated into the clothing or equipment of each of the players on the sports field 200. In some embodiments, each of the RFID antennas 301, 302, 303, 304, and 305 may be configured to detect and read a signal from each of the RFID transmitters on each of the players if the players are within a certain range 310 of one of the RFID antennas 301, 302, 303, 304, or 305. The signal from each of the RFID transmitters may comprise a unique identifier (e.g., one unique identifier for each player). In some embodiments, a timestamp for each of the unique identifiers corresponding to each of the players with an RFID transmitter may be recorded and stored if an RFID antenna reads a signal from an RFID transmitter that has passed within the range of the RFID antenna. For example, as illustrated, a player starting at the bench 210 with a path 320 may pass through the range of RFID antennas 301, 302, and 305. As such, a plurality of timestamps associated with the unique identifier of the RFID transmitter coupled to the player may be recorded for the RFID antennas 301, 302, and 305. The timestamps may indicate a time when the unique identifier of the RFID transmitter was read by the RFID antenna

In some embodiments, an RFID antenna in range of the player's RFID may simply register the time when the player's RFID was read by the antenna. In other embodiments, the antenna and associated RFID reading equipment may record the received signal strength (RSS) associated with the player's RFID and/or the angle or direction relative to the antenna from which the RFID signal associated with the player was received. An RFID tag's position may be identified by proximity to a particular antenna (for example, whether or not the RFID is in range of the antenna), or by any of a number of well-known localization and positioning techniques including triangulation, lateration, multilateration, angulation, and scene analysis. Scene analysis may be particularly appropriate to the constrained and bounded environment of a sports field. These localization and positioning techniques may take advantage of any characteristic of the RFID signal, including RSS, angle, or the times when different antennas receive the signal. The localization and positioning techniques could be enhanced through the use of anchor nodes.

As such, an overhead video camera and a plurality of RFID antennas may be placed over or in conjunction with a sports field. The overhead video camera may be used to generate an optical track and the RFID antennas may be used to generate timestamps of player locations associated with particular player identities. In some embodiments, the optical track may comprise position over time data (e.g., where the player of the optical track was at particular times). In the same or alternative embodiments, the timestamps from the RFID antennas may indicate when a particular RFID antenna has read from a particular RFID transmitter. In the same or alternative embodiments, the time associated with the optical track and the timestamps of the RFID antennas may be synchronized.

In some embodiments, RFID antennas may be placed in a ring around the hockey rink. In yet other embodiments, there may be only one or just a few RFID antennas. For example, an RFID antenna placed at a “choke point” where entrances and egresses occur, such as the player bench or penalty box, could be particularly helpful for logging players' entries and exits from the rink.

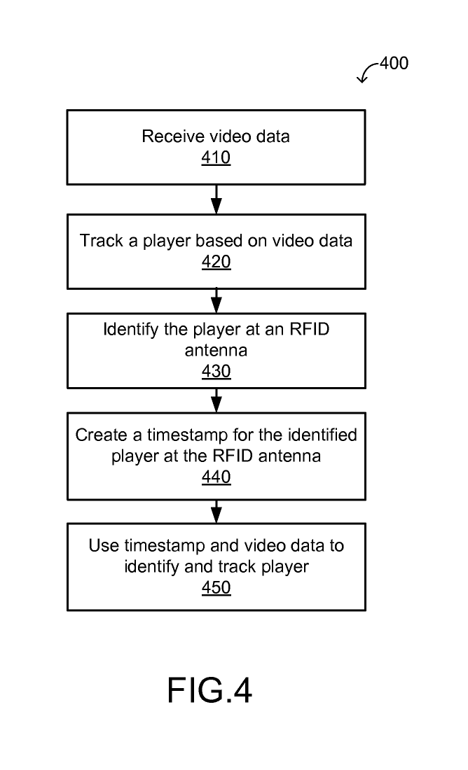

FIG. 4 is a flow diagram of a method 400 for tracking a player based on an optical track of a player and a timestamp associated with the player in accordance with some embodiments of the present disclosure. In general, the method 400 may be used to track a player on a sports field (e.g., sports field 200) and identify a player associated with an optical track based on timestamps from one or more RFID antennas (e.g., RFID antennas 301, 302, 303, 304, and/or 305). As shown in FIG. 4, the method 400 may receive, at step 410, video data. For example, video from an overhead video camera may be received. At step 420, a player may be tracked from the video data. For example, the video data may comprise video of a plurality of players on a sports field. In some embodiments, target tracking software may detect each player on the sports field and generate an optical track (e.g., optical tracks 211, 212, and/or 320) for each detected player. At step 430, players may be identified at an RFID antenna. For example, players with RFID transmitters on the sports field may enter the range (e.g., range 310) of an RFID antenna (e.g., RFID antenna 301, 302, 303, 304, and/or 305) and the RFID antenna may read a signal from the RFID transmitter. Next, at step 440, a timestamp may be created for the identified player at the RFID antenna. For example, a timestamp may be created to indicate a specific time that a unique identifier read from a signal of an RFID transmitter on a player was read by a specific RFID antenna. RFID timestamps may be used to identify the player associated with each optical track as each optical track is initiated (e.g., the player enters the field of view).

In some embodiments, multiple video cameras are used to track entities in the field of view of the optical system. When multiple video cameras are used, the raw video data from each camera may be sent as input to a mosaic stitch module. Using any of a number of well-known mosaic stitching techniques, all or part of the video data from each camera is combined to generate composite video data. For example, the video data could be stitched in advance, such that the system records a single video signal composed of video data from a plurality of cameras. Alternatively, for example, cameras may be calibrated independently (and potentially intercalibrated) so that optical tracks are generated in the same coordinate system, but there is no single image comprising the data of all cameras at the time of data acquisition. The optical system tracks individual entities and provides positional data (for example, x-y position over time) for each optically tracked entity based, in part, on the composite video data.

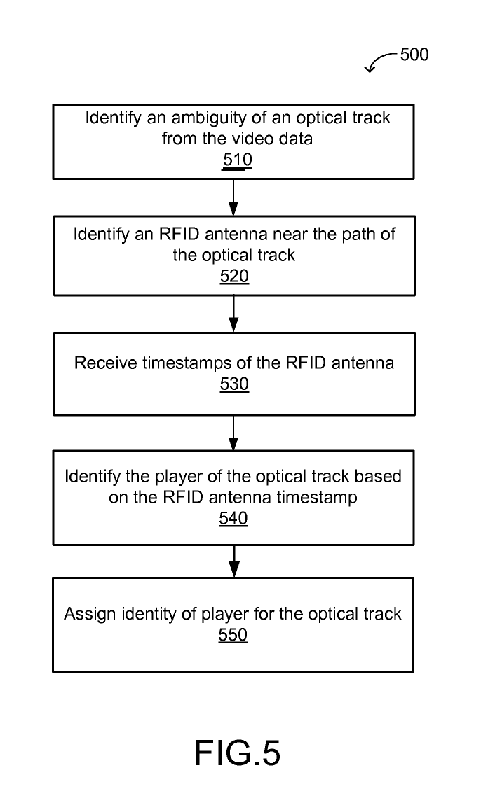

As such, optical tracks may be generated from video data. In some embodiments, the optical tracks may indicate position and time data of a player. For example, the optical track may indicate where a particular player was on the sports field at a particular time. In some embodiments, timestamps may be generated when a player has entered the range of an RFID antenna. In some embodiments, if an optical ambiguity occurs where two or more optical tracks become merged or the optical system cannot maintain continuous unique optical tracks for each player for any other reason, such as if a plurality of players are entering the sports field from a same region (e.g., bench 210) or if a plurality of players have collided (e.g., at point 213) or if players have passed through a region of weak or no video coverage, then RFID timestamp data may be used to identify a player associated with an optical track. For example, at step 450, a timestamp from an RFID antenna and an optical track may be used to identify a player associated with the optical track. Further details with regard to using timestamps for identifying a player associated with an optical track are discussed in further detail below with regard to FIG. 5.

Under some circumstances, manual entry of the identity of a player associated with a particular optical track may be necessary or desirable. Some embodiments include provisions for such manual entry including, for example, the ability to select a track and then select a player from a list of players who will then be associated with the selected track.

FIG. 5 is a flow diagram of a method 500 for identifying a player associated with an ambiguous optical track in accordance with some embodiments. In general, the method 500 may identify the player associated with an optical track (e.g., optical tracks 211, 212, and/or 320) by using information from the optical track and timestamps from one or more RFID antennas (e.g., RFID antennas 301, 302, 303, 304, and/or 305).

As shown in FIG. 5, at step 510, an ambiguity for identifying a player associated with an optical track is identified. For example, target tracking software may generate an optical track from video data. In some embodiments, the optical track may indicate position over time data for a single player on a sports field (e.g., sports field 200). In the same or alternative embodiments, a plurality of optical tracks are generated, where a single optical track is associated with a single player. In some embodiments, the target tracking software may issue a notification indicating an ambiguity in the identification of a player for a particular optical track. For example, the target tracking software may detect a player moving on the sports field, but may be unable to determine the identity of the player moving on the sports field. At step 520, an RFID antenna near the path of the optical track may be identified. For example, the optical track may pass within a range (e.g., range 310) of at least one RFID antenna (e.g., RFID antennas 301, 302, 303, 304, and/or 305). In some embodiments, the position of each RFID antenna on the sports field is known and the position data of the optical track may be used to identify which RFID antennas the optical path has approached. As such, an RFID antenna may be identified to be near the optical path based on the position of the RFID antenna, the range of an RFID antenna, and the positions indicated by the optical track. For example, the position data may indicate if the optical path has entered within a range of an RFID antenna. At step 530, timestamps associated with an RFID antenna near the path of the optical track may be received. For example, the timestamp associated with a time at or near the time associated with the optical path when it has entered the range of the RFID antenna may be received. In some embodiments, the timestamp may be associated with a unique identifier corresponding to a player. As such, at step 540, the player associated with the optical track may be identified as the player corresponding to the unique identifier from the timestamp. At step 550, the identity of the player from the timestamp may be assigned to the optical track as the optical track continues to be generated by the target tracking software.

As such, the target tracking software may be unable to identify the identity of a player for an optical track. In some embodiments, the optical track may indicate or comprise position and time data (e.g., position over time of a player on a sports field). A position of one or more RFID antennas on the sports field may be received. The positions of the RFID antennas may be compared with a position of the optical track to identify at least one RFID antenna where the optical track entered within the range of the RFID antenna. In some embodiments, the RFID antenna may record a timestamp in response to a player associated with an optical track entering the range of the RFID antenna. The timestamps of the identified RFID antenna may be received and timestamps with times identical to or close to a time when the optical track has entered the range of the RFID antenna may be identified. An identity of a player associated with a timestamp at a time identical or close to the time when the optical track entered the range of the RFID antenna may be assigned to the optical track.

Some optical tracks not associated with an identified player are considered anonymous tracks. Typically, a new anonymous track begins when a previously unseen entity enters the field of view. This situation may occur when a player on the bench or sidelines enters the game. As discussed above, a new anonymous track may begin when multiple optical entities visually merge into one. Once the entities separate and become individual optical entities once again, the tracks may be considered anonymous tracks where the system can no longer determine their identity with certainty. When an anonymous track is associated with a particular player identity, it ceases to be an anonymous track and becomes an identified track. All of the data previously associated with the anonymous track is now associated with the identified track.

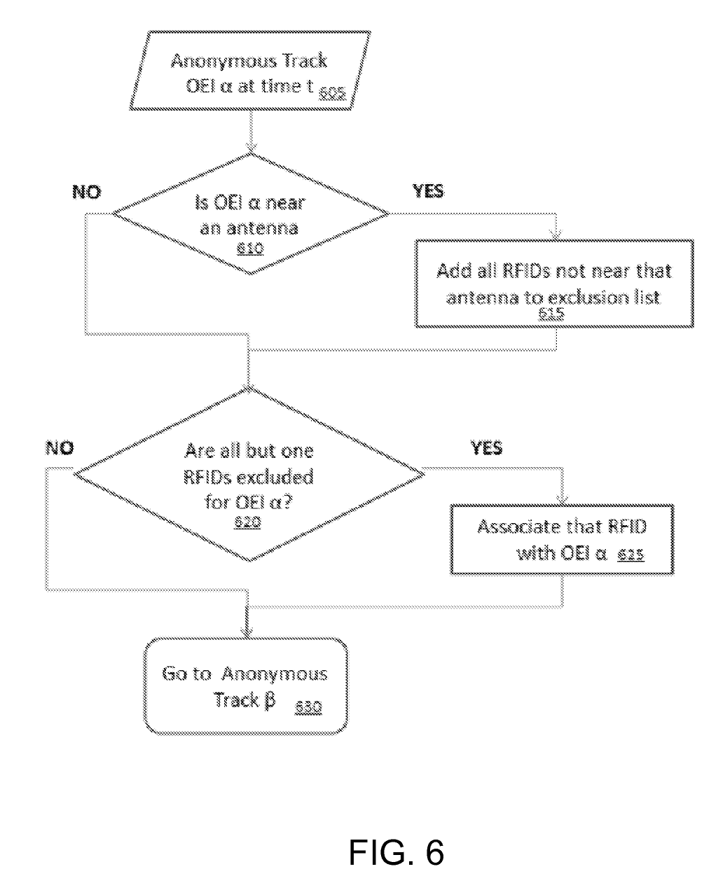

As shown in FIG. 6, an optical track identity assignment algorithm determines which player will be associated with an anonymous track based on the position of the optical track and RFID timestamps. At step 605, the algorithm begins by considering a plurality of RFID transmitters (e.g., the RFIDs associated with individual players) as potential matches for the optical track. If it is determined that an optical track is positioned near an RFID antenna at step 610, the RFID transmitters that are not currently near that RFID antenna are added to an exclusion list at step 615. The exclusion list includes all RFID transmitters that have been ruled out as being associated with the optical track. Once all RFID transmitters but one have been added to the exclusion list at step 620, the single remaining RFID transmitter is then associated with the optical track at step 625. It is also possible that the optical track belongs to an entity with no RFID transmitter at all. If all RFIDs have been excluded, the optical track is labeled as “No RFID”. The same process continues for the next anonymous optical track at step 630. At step 605, the exclusion list could initially be empty (meaning that the system initially considers all available RFID transmitters to be possible matches for the optical track) or the exclusion list might already be populated with some RFID transmitters (for example, with RFID transmitters that are already associated with other optical tracks).

RFID transmitters may be added to the exclusion list with confidence in a number of exclusion scenarios. In a first exclusion scenario, an optical track passes near an RFID antenna when the known position of the RFID transmitter is not near the RFID antenna. Because the optical track and the RFID transmitter are determined to be in different locations, the RFID transmitter is added to the exclusion list. In a second exclusion scenario, the known position of an RFID transmitter is near an antenna that is not located near the optical track. Again, because the optical track and the RFID transmitter are determined to be in different locations, the RFID transmitter is added to the exclusion list. In a third exclusion scenario, the RFID transmitter is already associated with a different optical track and is included in the exclusion list. Upon the expiration of the optical track associated with the RFID transmitter (for example, when a player leaves the field of view or cannot be distinguished from another player due to a collision or entering the player bench or players passing through a region of weak or no video coverage), the RFID transmitter is returned to the pool of possible RFID transmitters for associating with other anonymous optical tracks. In a fourth exclusion scenario, upon an optical entity merge (for example a collision or a player entering the player bench or players passing through a region of weak or no video coverage), all RFID transmitters other than those involved in the merge are excluded from the new tracks that start from the location of the merge.

The positions of individuals who are not players, including referees, linesmen, or other officials, could be tracked in a similar manner as the players are tracked. Data about the movement of officials and other non-players may be of interest, but even if their movements are not of interest, it may be beneficial to equip non-players with RFID transmitters to assist the system in disambiguating the optical paths associated with non-players from those associated with players.

Game information may be maintained in some embodiments. Game information may include the game clock and its associated starts and stoppages (i.e., correlating official game time, which may stop and start, with the system clock, which will typically be free running). Game information may also include game events, including face-offs, goals, and penalties. Game information may also include the game situation, including which period or overtime period the game is in and whether the play is at even strength or one team is on a power play.

Game information may be maintained in some embodiments using a game event log. Game time information stored in the game event log may include the game clock and its associated starts and stoppages (i.e., correlating official game time with the system clock). Game event information stored in the game event log may also include game events, including face-offs, goals, and penalties. Other information maintained in the game event log may include game situations, including which period or overtime period the game is in and whether the play is at even strength or one team is on a power play. All game event log entries are preferably entered using the same system clock as the optical and RFID systems. According to some embodiments, only clock events such as play-start and play-stop times are logged. Almost any other game event may be useful for some purposes and may be logged, such as face-offs, goals, penalties, timeouts, shots, passes, and power plays situations in hockey, and any other event associated with a time in any other sport or in any non-sporting scenario.

As previously disclosed, an RFID transmitter may be attached to each player on the sports field. In some embodiments, a sensor package may be attached to each player on the sports field. The sensor package may comprise a temperature sensor, heart rate monitor, or other physiological or physiometric sensors. Body, limb, or equipment position or orientation might also be recorded. In some embodiments, the sensor package may comprise an accelerometer. The sensor package may be used to measure a variety of activities of players on the sports field as well as their reactions to those activities.

In some embodiments, the system may be used to identify and track an amount of time that a specific player has spent in various zones or areas of the sports field. For any one entity, a continuous track of their position throughout the event is captured as an entity track. Each entity track comprises an RFID transmitter associated with the person's identity, timestamps, and x-y positions over time, using the free-running system clock. A game track for an entity may be observed based on an entity track and a game clock analysis. A game track comprises an RFID transmitter associated with the person's identity, timestamps, and horizontal and vertical positions only when the game clock analysis determines the game clock is running. A game track may be advantageous in some scenarios because data that is not relevant to actual in-game activity is discarded. For example, optical tracks of entities between periods and during timeouts may not be relevant for some purposes and may be discarded from the game track, though they remain part of the entity track.

Entity tracks and game tracks may be used to observe details specific to the type of game being played. For example, the entity track or game track associated with a player may be observed within a plurality of zones (e.g., attacking zone 220, neutral zone 230, and/or a defending zone 240) and the amount of time that the player has spent in each of the zones may be recorded. In some embodiments, player-to-player matchups may be identified and recorded. For example, target tracking software may record player matchups by detecting correlated movements from a plurality of optical tracks. A hockey defenseman's reaction to an oncoming “rush” by a forward might be tracked by the system, and the distance that the defenseman maintains from the forward may be observed from the optical tracks of each of the players. In hockey, the distance between a defenseman and a forward during a rush is called the defenseman's gap, and it may be advantageous to record data about a particular defenseman's gaps when forward rushes occur. In some embodiments, the target tracking software may identify and measure the amount of time that a team has spent in a style of defense by correlating the movements of optical tracks of players on one team against the movements of optical tracks of players on a second team. A “zone” or “trap” defense might be recognized by the system based on the x-y position data of the players when defensive situations occur.

As previously discussed, the position and movement of the puck (or ball in other sports) may be tracked in some embodiments. Possession data indicating who possesses the puck at any given time could be generated based on the player movement and puck movement data. Shots (including attempts, misses, saves, and goals) could be automatically recorded, and similar data might be recorded for passes, clears, and turnovers.

In some embodiments, a summary of the game played on the sports field may be generated based on the collected data. For example, statistics and data for each player may be generated. In the same or alternative embodiments, a total amount of distance skated by each player may be tracked, either in game clock time or while the free-running clock runs. Furthermore, the optical tracks may be used to determine a number of times that a player has entered and/or exited the sports field. For example, the optical track for a player may be observed to determine entry and exit from the bench 210 and the sports field 220.

Game information may be coupled with other information collected by the system in useful ways. For example, the system may automatically record which players are on the ice and which players are off the ice when game events like goals occur. Summary statistics of on-ice and off-ice events might be generated for each player. The length of each shift, and the total game time each player spent on the ice could be automatically tabulated. The system might also be used to generate reports regarding the amount of time each player spent playing in different situations, for example, the amount of time a player spent on the ice in shorthanded situations as compared to even strength or power play situations. Or the system might be used to report the amount of game time individual players spent on the ice with other players, either paired with specific teammates or facing specific opponent players.

Data from the physiological, physiometric, and/or accelerometer sensor packages might be combined with other data collected by the system. For example, the optical tracks and accelerometers may be used to determine a number of hits from a first player and other players by observing the optical tracks of the first player intersecting or coming together with the optical tracks of other players, in conjunction with rapid accelerations and decelerations associated with the hits. Or a player's heart rate might be observed through different levels of exertion as the player's optical track demonstrates faster or slower movements.

Position/movement, possession, game information, physiological/physiometric, and accelerometer data may be used in additional combinations. For example, the average number of hits per minute of game time that opposing players experience when a particular player is on the ice could be determined. Or the average speed with which a player skates at the beginnings of shifts could be compared with that player's average skating speed at the 45-second mark of shifts to assess the effect of fatigue on skating speed.

Position/movement, possession, game information, physiological/physiometric, and accelerometer data may be associated and synchronized with game video, from the previously mentioned cameras as well as other sources, including television broadcast footage, to provide additional analysis and presentation tools for use by, e.g., coaches, trainers, and television analysis. For example, a player motion track generated as described above might be displayed on screen in the manner of a telestrator while the player moves, in replay, through the track.

Physiological/physiometric, and accelerometer data may be analyzed by the system to estimate player fatigue and flag occurrences of player injury. Certain injuries, such as concussions, are difficult to detect with the naked eye. By associating accelerometer data with an entity track, the system may flag an entity or timestamp or otherwise produce an alert message when an entity track is associated with accelerometer data that exceeds a certain value. Instances of player fatigue may be determined by the system based on heart rate readings, by measuring an entity's top-end speed or other performance indicators and detecting variations from baseline values, or by other well-known means for detecting fatigue.

As previously disclosed, the localization and positioning techniques may be enhanced through the use of anchor nodes. In some embodiments, RFID transmitters may be placed in or around the field of view that act as anchor nodes. Anchor nodes may be placed at known locations among the RFID antennas to act as reference points for calibrating the localization and positioning techniques used when an RFID transmitter comes within range of one or more RFID antennas. In some embodiments (with or without anchor nodes), calibration of the localization and positioning techniques is accomplished by allowing an RFID transmitter to move along a predetermined path among the RFID antennas and recording the signal strength experienced by the RFID antennas.

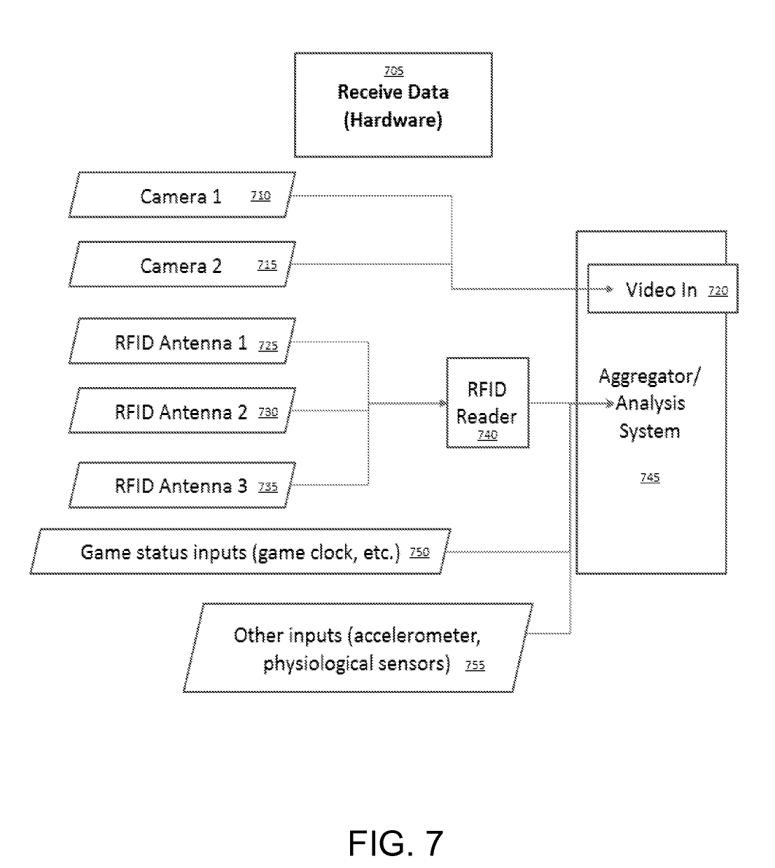

As shown in FIG. 7, computer hardware and software is configured to receive data from several input sources. As an example, this particular embodiment includes cameras 710 and 715 generating video input 720 passed to the Aggregator and Analysis System 745. The data captured by an RFID Antenna (e.g., RFID antennas 725, 730, and/or 735) is first passed to an RFID Reader 740 which parses the captured data, isolating the desired data from each antenna (check-ins or RSS) before passing the data to the Aggregator and Analysis System 745. As previously discussed, a timestamp for each of the unique identifiers corresponding to the players with an RFID transmitter may be recorded and stored when an RFID antenna reads a signal from an RFID transmitter that has passed within the range of the RFID antenna in some embodiments. In some embodiments, the RFID Reader reads analog or digital signals from each RFID Antenna which indicates the signal strength of the RF signal received from an RFID transmitter, or the angle of the RF signal received from an RFID transmitter as determined by one or more RFID Antennas, or both. The Aggregator and Analysis System also receives other forms of input, including game status inputs 750 (such as game clock, game score, etc.) and miscellaneous input 755 (such as data gathered from accelerometers or physiological sensors).

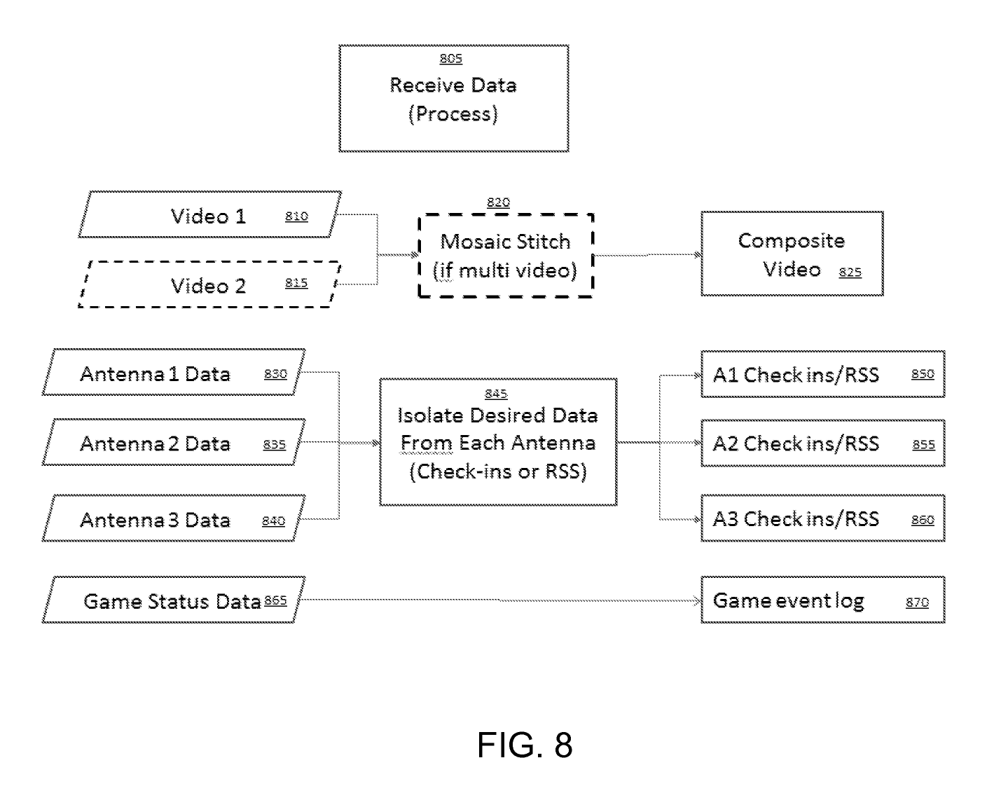

As shown in FIG. 8, the system is configured to process the raw data received from several input sources into a form that is suitable for analysis, optical tracking and data logging. In some embodiments, video data from video inputs 810 and 815 is processed using any of a number of well-known mosaics stitching techniques 820. The output of the stitching process is composite video data 825 that can be subsequently analyzed to generate and identify optical tracks. In some embodiments, a single video source is used and no mosaic stitch techniques are required. In the case of a single video source, the video input is simply treated as composite video data 825 without applying mosaic stitching. Raw RFID antenna data received from an RFID antenna (e.g., RFID antennas 830, 835, and/or 840) is also processed by the system at step 845 in order to isolate the desired data (e.g., data 850, 855, and/or 860) from each antenna (such as check-ins or RSS). Additionally, all game status data 865 entered into the system, such as game events, system time, game time, and on-ice/off-ice time for each entity or RFID transmitter is maintained using game event log 870.

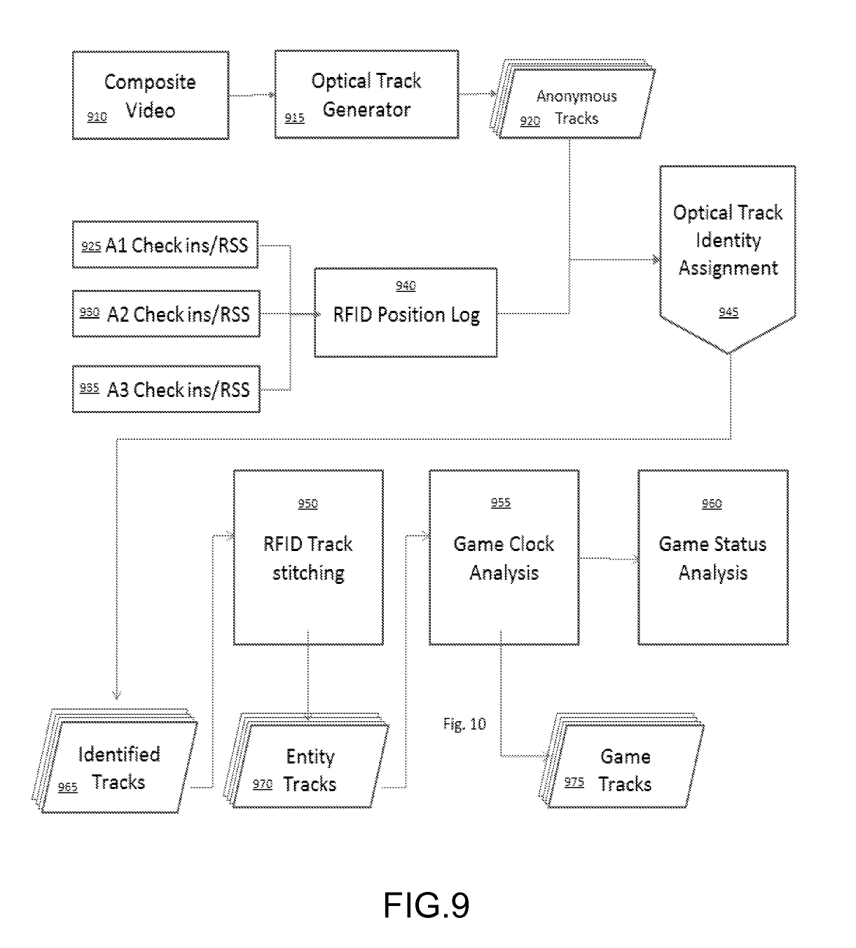

As shown in FIG. 9, in some embodiments the system is configured to analyze processed data in order to assign an identity to an anonymous optical track. Raw video data that has been processed into composite video data 910 or taken from a single video source is analyzed by the optical track generator 915. As previously described in reference to FIG. 2, tracking software may track an optical path of a first player. In some embodiments, the target tracking software may further track an optical path of a second player. At this stage of analysis, the identity of the player or person associated with the optical path may be unknown. The system also analyzes the processed Check-in/RSS data (e.g., data 925, 930, and/or 935) from each RFID antenna and updates positional data to RFID position log 940. In some modes of operation, where continuous data is preferred, RFID position log 940 comprises the identity of the antenna, time, and the identity of RFIDs in proximity. The RSS for each RFID transmitter or angle of each RFID transmitter relative to the antenna may also be stored in RFID position log 940. In some modes of operation, where non-continuous data is preferred, RFID position log 940 comprises the identity of the RFID transmitter, the time of check-in or RSS reading of the RFID transmitter, and the identity of the RFID antenna. The position log 940 may store the angle of the RFID signal relative to the antenna in this situation as well.

As previously described, the events captured in RFID position log 940 are used to assign an identity to the anonymous optical tracks at step 945. Anonymous optical tracks that are subsequently associated with an RFID transmitter or otherwise identified are stored as identified tracks 965. But there may be several identified tracks for a given player or entity. The identified tracks 965 associated with a particular RFID transmitter undergo RFID track stitching at step 950 to generate an entity track 970. An entity track comprises an RFID associated with the person's identity, timestamps, and all horizontal and vertical positions recorded throughout the tracking period, such that there is only one entity track for each tracked entity. In other words, the entity tracks combine each identified track associated with each entity being tracked throughout the tracking period. Entity tracks 970 may be further analyzed in view of game clock data taken as input by the system. A non-continuous game track for an entity may be observed and logged based on game clock analysis 955. A game track 975 typically comprises an RFID associated with the person's identity, timestamps, and horizontal and vertical positions recorded only when the game clock analysis determines the game clock is running (active). A game track may be advantageous in some scenarios because data that is not relevant to actual in-game activity is discarded. For example, as mentioned above, a total amount of distance skated by each player may be tracked. If entity tracks are used for this purpose, then the total distance covered during the event, including stoppages in play, will be determined. But if game tracks are used for this purpose, then only the distance traveled while the game clock runs will be included, and distance skated during stoppages will not be included. A final step before data analysis terminates manages all position-independent data entered into the system at game status analysis 960. Position-independent data comprises game events, system time, game time, and on-ice/off-ice time for each entity or RFID transmitter.

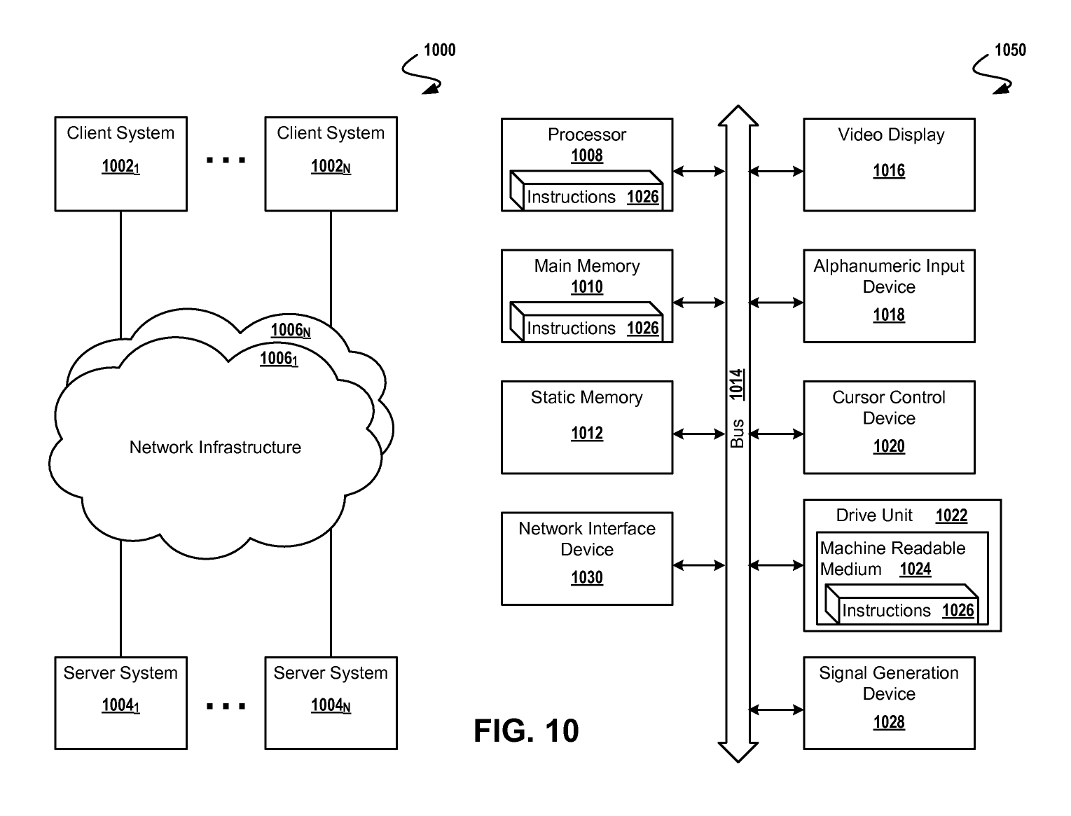

FIG. 10 depicts a diagram illustrating a network 1000 for execution of the operations comprising various embodiments of the disclosure. The diagrammatic representation of the network 1000, including nodes for client computer systems 1002₁ through 1002_{N}, nodes for server computer systems 1004₁ through 1004_{N}, nodes for network infrastructure 1006₁ through 1006_{N}, any of which nodes may comprise a machine 1050 within which a set of instructions for causing the machine to perform any one of the techniques discussed above may be executed. The embodiment shown is purely exemplary, and might be implemented in the context of one or more of the figures herein.

Any node of the network 1000 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1050 includes a processor 1008 (e.g. a processor core, a microprocessor, a computing device, etc.), a main memory 1010 and a static memory 1012, which communicate with each other via a bus 1014. The machine 1050 may further include a display unit 1016 that may comprise a touch-screen, or a liquid crystal display (LCD), or a light emitting diode (LED) display, or a cathode ray tube (CRT). As shown, the computer system 1050 also includes a human input/output (I/O) device 1018 (e.g., a keyboard, an alphanumeric keypad, etc.), a pointing device 1020 (e.g., a mouse, a touch screen, etc.), a drive unit 1022 (e.g. a disk drive unit, a CD/DVD drive, a tangible computer readable removable media drive, an SSD storage device, etc.), a signal generation device 1028 (e.g. a speaker, an audio output, etc.), and a network interface device 1030 (e.g. an Ethernet interface, a wired network interface, a wireless network interface, a propagated signal interface, etc.).

The drive unit 1022 includes a machine-readable medium 1024 on which is stored a set of instructions (i.e. software, firmware, middleware, etc.) 1026 embodying any one, or all, of the methodologies described above. The set of instructions 1026 is also shown to reside, completely or at least partially, within the main memory 1010 and/or within the processor 1008. The set of instructions 1026 may further be transmitted or received via the network interface device 1030 over the network bus 1014.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

Further disclosed are additional figures illustrating embodiments for identifying a player associated with an optical track. Portions of the additional figures may correspond to FIGS. 1-10. For example, an “anonymous track” may correspond to an optical track where the identity of the player associated with the optical track is unknown and an “optical entity” may correspond to a player that will be tracked by target tracking software to generate an optical track. In some embodiments, the “RFID position log” may correspond to the timestamps as previously disclosed. In some embodiments, the optical track identity assignment algorithm may correspond to a method for assigning a player identity to an optical track. Furthermore, the additional figures illustrate additional features with regard to a system and method to track players based on video data and RFID data.

What is claimed is:

1. A method for tracking players, the method comprising:
receiving video data of a sports field, the video data comprising a plurality of optical tracks of players on the sports field, a first optical track corresponding to a first player, the identity of the first player not being ascertained based on the optical data alone;
identifying an RFID antenna associated with the first optical track; and
determining, by a computer, the identity of the first player associated with the first optical track, the identification being based on the first optical track and radio-frequency identification (RFID) data associated with the RFID antenna.

2. The method as set forth in claim 1, wherein the identifying of the RFID antenna is based on a position of the RFID antenna and a path of the first optical track.

3. The method a set forth in claim 2, wherein the RFID antenna associated with the first optical track is identified by observing the path of the first optical track entering within a range of the RFID antenna at the position of the RFID antenna.

4. The method as set forth in claim 1, wherein the RFID data comprises a timestamp associated with the first player.

5. The method as set forth in claim 4, wherein the timestamp identifies a time when a unique identifier associated with the first player has been read by the RFID antenna.

6. The method as set forth in claim 1, wherein each player on the sports field wears an RFID transmitter having a unique identifier, the RFID transmitters capable of being read by the RFID antenna.

7. A method to identify players on a sports field, the method comprising:
receiving a first optical track associated with a first player and a second optical track associated with a second player, the identities of the players not being ascertained based on optical data alone;
receiving, from a plurality of RFID antennas, timestamps corresponding to an identification of at least one player and at least one time when the player has been within a range of an RFID antenna; and
determining the identity of a first player associated with the first optical track and a second player associated with the second optical track based on the timestamps from the plurality of RFID antennas.

8. The method as set forth in claim 7, wherein the optical tracks comprise position over time data.

9. The method as set forth in claim 8, wherein the determining of the identity of the first player involves selecting timestamps from a first RFID antenna based on a position of the first RFID antenna and the position data of the first optical track.

10. A system comprising one or more computers for tracking one or more players on a sports field, the system comprising:
at least one video camera generating a video signal representing a sports field;
a video subsystem that receives the video signal and generates at least one optical track of players on the sports field, wherein a first optical track corresponds to a first player, and the identity of the first player is not ascertained based on the optical data alone;
a set of one or more RFID antennas placed on or near the sports field;
a plurality of RFID transmitters, at least one of said transmitters being attached to the first player, the system being capable of identifying the first player based on the RFID transmitter attached to the first player; and
a subsystem that associates the identity of the first player with the first optical track, the identification being based on the first optical track and information relating to the physical relationship between at least one RFID transmitter and at least one RFID antenna.

11. The system as set forth in claim 10, wherein the association of the identity of the first player with the first optical track is based, at least in part, on a position of the RFID antenna and a path of the first optical track.

12. The system as set forth in claim 10, wherein the association of the identity of the first player with the first optical track is based, at least in part, on a position of the RFID antenna and a path of at least one optical track of at least one player other than the first player.

13. The system as set forth in claim 10, wherein the information relating to the physical relationship between at least one RFID transmitter and at least one RFID antenna comprises a timestamp associated with the first player.

14. The system as set forth in claim 10, wherein the optical tracks comprise position over time data.

15. The system as set forth in claim 10, wherein the association of the identity of the first player with the first optical track involves selecting timestamps from a first RFID antenna based on a position of the first RFID antenna and the position data of the first optical track.

16. The system as set forth in claim 10, wherein the system further generates a real time tracking of the first player that includes the first player's position over time and the first player's identity.

17. The system as set forth in claim 10, further comprising a display monitor, coupled to the video subsystem and the subsystem, that displays a track of the first player and also displays information indicating the identity of the first player associated with the track of the first player.

18. The system as set forth in claim 10, wherein:
the video subsystem further generates a plurality of optical tracks for a plurality of players on the sports field, wherein each of the optical tracks corresponds to one of the players; and
the subsystem further associates the identity of each player with an optical track based on the optical track and information relating to the physical relationship between the RFID transmitter of the player and at least one RFID antenna.

19. The system as set forth in claim 18, further comprising a display monitor that displays an optical track for each of the players on the display and displays information indicating the identity of each player associated with said track on the display.
